(19) United States
(12) Patent Application Publication
(10) Pub. No.: US 2007/0098069 A1
(43) Pub. Date: May 3, 2007

(54) Inverse scan, coefficient, inverse quantization and inverse transform system and method

(76) Inventor: Stephen Gordon, North Andover, MA (US)

Correspondence Address: MCANDREWS HELD & MALLOY, LTD, 500 WEST MADISON STREET, SUITE 3400, CHICAGO, IL, 60661, US

(21) Appl. No.: 11/411,327

(22) Filed: Apr. 26, 2006

Related U.S. Application Data
(60) Provisional application No. 60/675,140, filed on Apr. 27, 2005.
(60) Provisional application No. 60/675,166, filed on Apr. 27, 2005.
(60) Provisional application No. 60/675,377, filed on Apr. 27, 2005.
(60) Provisional application No. 60/675,144, filed on Apr. 27, 2005.

(51) Int. Cl. H04N 7/12; H04N 11/04

(52) U.S. Cl. 375/240.12; 375/240.18

(57) ABSTRACT

Presented herein are inverse scan, coefficient prediction, inverse quantization and inverse transform system(s) and method(s). In one embodiment, there is presented a system for converting scanned quantized frequency coefficients to pixel domain data. The system comprises a first circuit and a second circuit. The first circuit converts scanned quantized frequency coefficients to pixel domain data, wherein the scanned quantized frequency coefficients encode video data in accordance with a first encoding standard. The second circuit converts scanned quantized frequency coefficients to pixel domain data, wherein the scanned quantized frequency coefficients encode video data in accordance with a second encoding standard.

### RELATED APPLICATIONS

This application claims priority to Provisional Application Ser. No. 60/675,140, “Inverse Quantization and Transform System and Method,” filed Apr. 27, 2005 by Gordon. This application is also related to the following patent applications each of which are incorporated herein by reference. Provisional Application Ser. No. 60/675,166, “Reconstruction And Overlap Transform System And Method Supporting VC-1 Decoding,” filed Apr. 27, 2005 by Gordon, Provisional Application Ser. No. 60/675,377, “System And Method For Overlap Transforming And Deblocking,” filed Apr. 27, 2005 by Gordon and Provisional Application Ser. No. 60/675,144, “Decoder System For Decoding Multi-Standard Encoded Video,” filed Apr. 27, 2005 by Gordon which is incorporated by reference herein for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

There are a variety of standards for encoding and compressing video data. Among the standards are MPEG-2, H.264 (also known as MPEG-4, Part 10), MPEG-4, Part 2, AVS, and SMPTE VC-1.

A decoder that is capable of decoding video data encoded with numerous standards is also capable of decoding a greater amount of video content. However, the foregoing standards have a number of differences that complicate the decoding.

The MPEG-2, H.264, and VC-1 standards have a number of differences. For example, the VC-1 standard uses quantized frequency coefficient prediction. Quantized frequency coefficient prediction is not used in either MPEG-2 or H.264. Additionally, MPEG-2 and H.264 use frequency scale factors for AC components, while VC-1 uses a uniform scale factor for the AC components. Finally, while MPEG-2 uses an 8×8 discrete cosine transform (DCT), H.264 and VC-1 use variable block size integer transforms. For H.264, 2×2, 4×4, and 8×8 block sizes are used. For VC-1, 4×4, 4×8, 8×4, and 8×8 block size are used.

Additional limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are inverse scan, coefficient prediction, inverse quantization and inverse transform system(s) and method(s), substantially as shown in and/or described in connection with at least one of the figures, and as set forth more fully in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is a block diagram of an exemplary circuit in accordance with an embodiment of the present invention;

FIG. 2 is a block diagram of a video decoder in accordance with an embodiment of the present invention;

FIG. 3 is a block diagram of an ISQT in accordance with an embodiment of the present invention;

FIG. 4 is a block diagram of a VC-1 ISQT in accordance with an embodiment of the present invention;

FIG. 5 is a block diagram of an H.264 ISQT in accordance with an embodiment of the present invention;

FIG. 6 is a block diagram of an MPEG-2 ISQT in accordance with an embodiment of the present invention; and

FIG. 7 is a flow diagram for converting scanned quantized frequency coefficients to pixel domain data in accordance with an embodiment of the present invention.

### DETAILED DESCRIPTION OF THE INVENTION

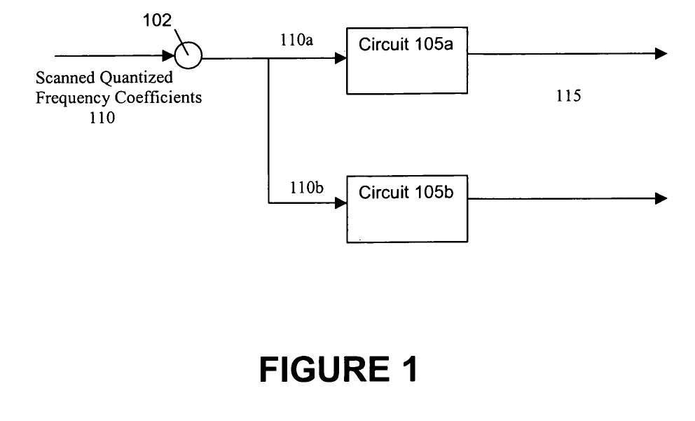

Referring now to FIG. 1, there is illustrated a block diagram of an exemplary circuit for converting scanned quantized frequency coefficients to pixel domain data, in accordance with an embodiment of the present invention. The circuit comprises an input 102, circuit 105a, and circuit 105b.

Input 102 receives scanned quantized frequency coefficients 110. There are a number of different video encoding standards. Many of the video encoding standards use transformations to transform video pixel domain data to frequency domain coefficients, quantization to quantize the frequency coefficients, and scanning to order the frequency coefficients for improved entropy encoding.

Scanned frequency coefficients can comprise, for example, but are not limited to, the scanned frequency coefficients representing video data that is encoded in accordance with an encoding standard, such as H.261, H.263, H.264, MPEG-2, MPEG-4 Part 2, VC-1, and AVS which are incorporated herein by reference for all purposes.

It is noted that the input 102 may receive scanned quantized frequency coefficients 110 representing video data that is encoded in accordance with any number of encoding standards. Pixel domain data from may be transformed to frequency coefficients in a different manner from encoding standard to encoding standard. Additionally, the frequency coefficients may be quantized and scanned differently from encoding standard to encoding standard.

The first circuit converts 105a the scanned quantized frequency coefficients 110a to pixel domain data 115, if scanned quantized frequency coefficients encode video data in accordance with a first encoding standard. The second circuit converts 105b scanned quantized frequency coefficients 110b to pixel domain data 115, if the scanned quantized frequency coefficients encode video data in accordance with a second encoding standard. In certain embodiments of the present invention, the first encoding standard and the second encoding standard can comprise, for example, any one of H.261, H.263, H.264, MPEG-2, MPEG-4 Part 2, VC-1 or AVS.

In certain embodiments of the present invention, the particular encoding standard associated with the quantized frequency coefficients 110 is determined by examining an indicator.

Certain embodiments of the present invention can include a video decoder receiving scanned quantized frequency coefficients that have been entropy encoded.

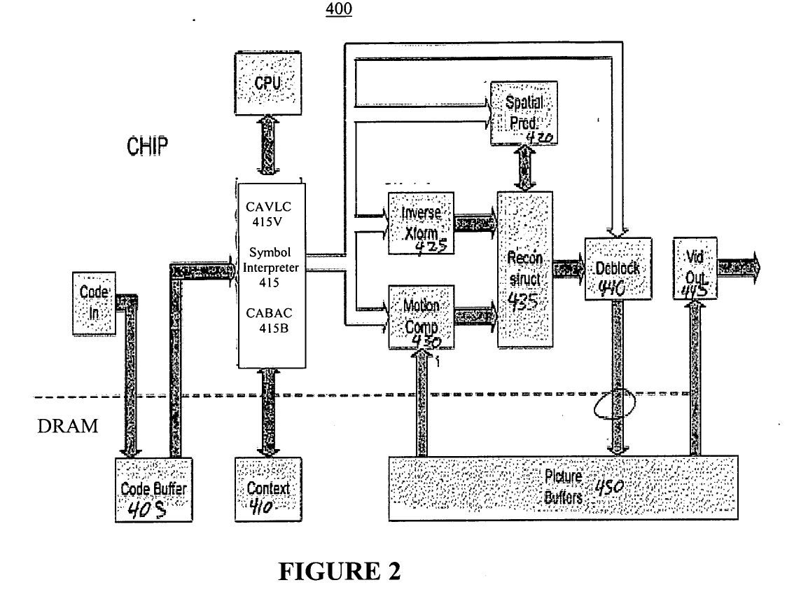

Referring now to FIG. 2, there is illustrated a block diagram describing an exemplary video decoder 400 in accordance with an embodiment of the present invention. The video decoder 400 includes a code buffer 405 for receiving a video elementary stream. The code buffer 405 can be a portion of a memory system, such as a dynamic random access memory (DRAM). A symbol interpreter 415 in conjunction with an entropy decoder converts the coded bitstream into syntax elements specified by the encoding standard. In certain embodiments, the entropy decoder may contain a context or variable length codeword table memory 410. The memory 410 can be another portion of the same memory system as the code buffer 405, or a portion of another memory system.

Where H.264 is supported, the symbol interpreter 415 may include a CAVLC decoder 415V and a CABAC decoder 415B. The CAVLC decoder 415V decodes CAVLC symbols, resulting in the sets of scanned quantized frequency coefficients. The CABAC decoder 415B decodes the CABAC symbols resulting in the side information.

The symbol interpreter 415 provides the sets of scanned quantized frequency coefficients to an inverse scanner, quantizer, and transformer (ISQT) 425. Depending on the prediction mode for the macroblock 120 associated with the scanned quantized frequency coefficients, the symbol interpreter 415 additionally provides side information to a pixel prediction unit. The prediction unit can be either a spatial predicter 420 (if spatial prediction) or a motion compensator 430 (if temporal prediction)

The ISQT 425 constructs the prediction error E. The spatial predictor 420 generates the prediction pixels P for spatially predicted macroblocks while the motion compensator 430 generates the prediction pixels P for temporally predicted macroblocks. The motion compensator 430 retrieves the prediction pixels P from picture buffers 450 that store previously decoded frames 100 or fields 110.

A pixel reconstructor 435 receives the prediction error E from the ISQT 425, and the prediction pixels from either the motion compensator 430 or spatial predictor 420. The pixel reconstructor 435 reconstructs the macroblock 120 from the foregoing information and provides the macroblock 120 to a “in-loop” filter 440. The in-loop filter 440 optionally smoothes pixels at the edge of the macroblock 120 to prevent the appearance of blocking artifact. The in-loop filter 440 writes the decoded macroblock 120 to the picture buffer 450.

A display engine 445 provides the frames 100 from the picture buffer 450 to a display device. The symbol interpreter 415, the ISQT 425, spatial predictor 420, motion compensatory 430, pixel reconstructor 435, in-loop filter 440 and display engine 445 can be hardware accelerators under the control of a central processing unit (CPU). The CPU performs a number of functions, including the management of off-chip DRAM that is allocated to the video decoder 400.

The ISQT 425 is capable of inverse scanning, coefficient prediction, inverse quantizing, and inverse transforming video data that is encoded in accordance with the H.261, H.263, H.264, MPEG-2, MPEG-4 Part 2, VC-1, and AVS standards. The CPU communicates the type of video data that is to be decoded to the ISQT 425. Additionally, the CPU may allocate a portion of on-chip or off-chip memory to the ISQT 425.

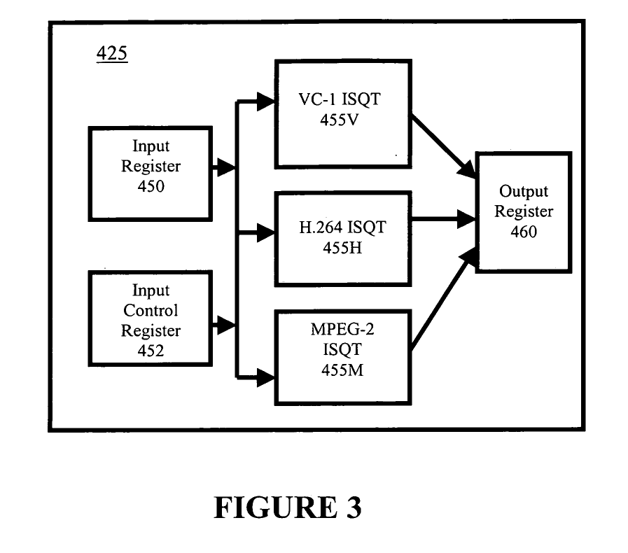

Referring now to FIG. 3, there is illustrated a block diagram describing an exemplary ISQT 425. The ISQT 425 comprises input registers 450, an input control register 452, an MPEG-2 ISQT 455M, an H.264 ISQT 455H, and a VC-1 ISQT 455V, and an output register 460. It is noted that although the ISQT 452 in the illustrated embodiment includes ISQT for MPEG-2, H.264, and VC-1, the ISQT 452 may include additional ISQT such as ISQT for MPEG-4, Part 2, and AVS. The MPEG-2 ISQT 455M is operable to inverse scan, inverse quantize, and inverse transforms video data encoded in accordance with the MPEG-2 standard. The H.264 ISQT 455H is operable to inverse scan, inverse quantize, and inverse transform video data encoded in accordance with the H.264 standard. The VC-1 ISQT 455V is operable to inverse scan, perform coefficient prediction, inverse quantize, and inverse transform video data encoded in accordance with the VC-1 standard.

The ISQT 425 receives the scanned quantized frequency coefficients at input register 450. The CPU communicates the particular video encoding standard of the scanned quantized frequency coefficients by writing a parameter to the input control register 452, indicating the video encoding standard. Responsive thereto, the appropriate one of the MPEG-2 ISQT 455M, H.264 ISQT 455H, and VC-1 ISQT 455V inverse scans, coefficient prediction, inverse quantizes, and inverse transforms the video data.

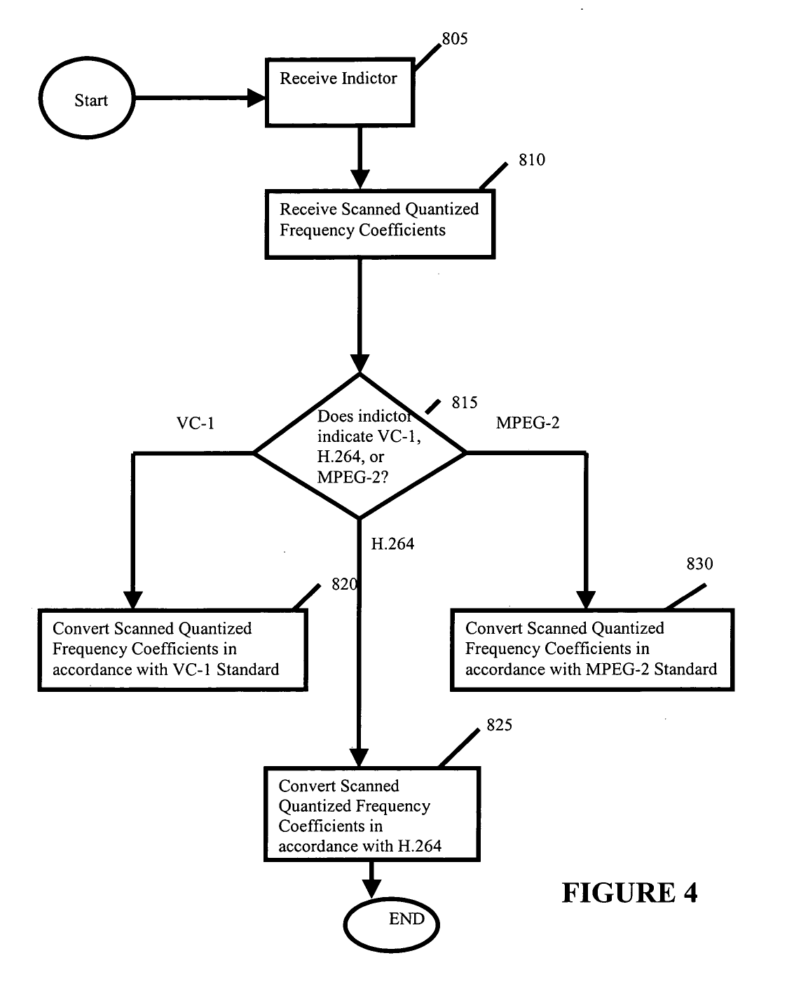

Referring now to FIG. 4, there is illustrated a flow diagram for converting scanned quantized frequency coefficients to pixel domain data in accordance with an embodiment of the present invention. At 805, the ISQT 455 receives an indicator from the CPU indicating the encoding standard for the scanned quantized frequency coefficients. At 810, the ISQT 425 receives the scanned quantized frequency coefficients.

If at 815, the indicator indicates that the scanned quantized frequency coefficients encode video data in accordance with VC-1, the ISQT 455V inverse scans, inverse quantizes, and inverse transforms the scanned quantized frequency coefficients in accordance with the VC-1 standard at 820.

If at 815, the indicator indicates that the scanned quantized frequency coefficients encode video data in accordance with H.264, the ISQT 455H inverse scans, inverse quantizes, and inverse transforms the scanned quantized frequency coefficients in accordance with the H.264 standard at 825.

If at 815, the indicator indicates that the scanned quantized frequency coefficients encode video data in accordance with MPEG-2, the ISQT 455M inverse scans, inverse quantizes, and inverse transforms the scanned quantized frequency coefficients in accordance with the MPEG-2 standard at 830.

The embodiments described herein may be implemented as a board level product, as a single chip, application specific integrated circuit (ASIC), or with varying levels of the decoder system integrated with other portions of the system as separate components.

The degree of integration of the decoder system may primarily be determined by the speed and cost considerations. Because of the sophisticated nature of modern processor, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on VC-1, H.264, and MPEG-2 encoded video data, the invention can be applied to a video data encoded with a wide variety of standards, such as video data encoded with MPEG-4, Part 2, or AVS.

Therefore, it is intended that the present invention not be limited to the particular embodiment disclosed, but that the present invention will include all embodiments falling within the scope of the appended claims.

1. A system for converting scanned quantized frequency coefficients to pixel domain data, said system comprising:
an input for receiving scanned quantized frequency coefficients;
a first circuit for converting the scanned quantized frequency coefficients to pixel domain data, if scanned quantized frequency coefficients encode video data in accordance with a first encoding standard; and
a second circuit for converting scanned quantized frequency coefficients to pixel domain data, if the scanned quantized frequency coefficients encode video data in accordance with a second encoding standard.

2. The system of claim 1, wherein the first encoding standard is VC-1, and the second encoding standard is H.264.

3. The system of claim 2, further comprising:
a third circuit for converting scanned quantized frequency coefficients to pixel domain data, wherein the scanned quantized frequency coefficients encode video data in accordance with MPEG-2.

4. The system of claim 1, wherein the first circuit comprises a coefficient predictor for predicting quantized frequency coefficients.

5. The system of claim 1, further comprising:
input registers for receiving scanned quantized frequency coefficients, the scanned quantized frequency coefficients encoded in accordance with the first encoding standard or the second encoding standard.

6. The system of claim 5, further comprising:
an input control register for storing an indicator, said indicator indicating whether the scanned quantized frequency coefficients are encoded in accordance with the first encoding standard or the second encoding standard.

7. The system of claim 6, wherein the indicator is written to the input control register by a controller.

8. A method for converting scanned quantized frequency coefficients to pixel domain data, said method comprising:
receiving an indicator indicating an encoding standard, wherein the scanned quantized frequency coefficients are encoded in accordance with the encoding standard;
converting the scanned quantized frequency coefficients to pixel domain data in accordance with a first standard, wherein the indicator indicates that the scanned quantized frequency coefficients are encoded in accordance with the first standard; and
converting the scanned quantized frequency coefficients to pixel domain data in accordance with a second standard, wherein the indicator indicates that the scanned quantized frequency coefficients are encoded in accordance with the second standard.

9. The method of claim 8, wherein the first encoding standard is VC-1, and the second encoding standard is H.264.

10. The method of claim 9, further comprising:
converting the scanned quantized frequency coefficients to pixel domain data in accordance with MPEG-2, wherein the indicator indicates that the scanned quantized frequency coefficients are encoded in accordance with MPEG-2.

11. The method of claim 8, wherein converting the scanned quantized frequency coefficients to the pixel domain data in accordance with the first standard further comprises:
predicting quantized frequency coefficients.
